(19) United States
(12) Patent Application Publication
(10) Pub. No.: US 2025/0209278 A1
(43) Pub. Date: Jun. 26, 2025

(54) IDENTIFYING SPEAKER NAMES IN TRANSCRIPTS UTILIZING LANGUAGE MODELS

(71) Applicant: Adobe Inc., San Jose, CA (US)

(72) Inventors: Minh Nguyen, Eugene, OR (US); Franck Dernoncourt, Seattle, WA (US); Hanieh Deilamsalehy, Seattle, WA (US); Hao Tan, San Jose, CA (US); Quan Tran, San Jose, CA (US); Seunghyun Yoon, Seoul (KR); Trung Bui, San Jose, CA (US)

(21) Appl. No.: 18/391,100

(22) Filed: Dec. 20, 2023

(51) Int. Cl. G06F 40/35

(52) U.S. Cl. CPC G06F 40/35

(57) ABSTRACT

The present disclosure relates to systems, non-transitory computer-readable media, and methods for identifying speaker names in transcripts. In particular, in one or more embodiments, the disclosed systems determine, from a set of sentences in a textual transcript of a dialogue, a first sentence spoken by a first speaker and a second sentence spoken by a second speaker. Additionally, in some embodiments, the disclosed systems generate a first feature representation for the first sentence and a second feature representation for the second sentence. Moreover, in some embodiments, the disclosed systems determine a speaker name for at least one of the first sentence or the second sentence by comparing each of the first feature representation and the second feature representation with a name representation for a name spoken in at least one of the first sentence or the second sentence.

### BACKGROUND

Recent years have seen developments in hardware and software platforms implementing transcription systems. For example, conventional transcription systems generate textual transcripts of conferences or speeches from audio or video recordings. Unfortunately, conventional systems often are unable to accurately identify speakers from a textual transcript of the conference or speech.

### BRIEF SUMMARY

Embodiments of the present disclosure provide benefits and/or solve one or more problems in the art with systems, non-transitory computer-readable media, and methods for identifying speaker names in a dialogue transcript utilizing deep learning language models. For example, in one or more embodiments, the disclosed systems determine a name spoken in the transcript and one or more sentences around the spoken name. Specifically, in some embodiments, the disclosed systems utilize a trained deep learning language model to generate feature representations of the spoken name and the sentences around the spoken name. Moreover, in some implementations, the disclosed systems compare the representation of the spoken name with the representations of the sentences to match the spoken name with a speaker of one of the sentences. For example, in some embodiments, the disclosed systems determine pair vectors for each sentence representation with the name representation. Utilizing the deep learning language model, in some implementations, the disclosed systems determine probability scores from the pair vectors to determine whether the spoken name belongs to one of the speakers of the sentences.

The following description sets forth additional features and advantages of one or more embodiments of the disclosed methods, non-transitory computer-readable media, and systems. In some cases, such features and advantages are evident to a skilled artisan having the benefit of this disclosure, or may be learned by the practice of the disclosed embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which a speaker identification system operates in accordance with one or more embodiments.

FIG. 2 illustrates the speaker identification system determining a speaker name for a sentence in accordance with one or more embodiments.

FIG. 3 illustrates the speaker identification system determining a speaker name from a spoken name in accordance with one or more embodiments.

FIG. 4 illustrates the speaker identification system determining multiple speaker names from a single sentence of a transcript in accordance with one or more embodiments.

FIG. 5 illustrates the speaker identification system generating a training dataset for a language model in accordance with one or more embodiments.

FIG. 6 illustrates a diagram of an example architecture of a digital media management system and speaker identification system in accordance with one or more embodiments.

FIG. 7 illustrates a flowchart of a series of acts for identifying speaker names in transcripts in accordance with one or more embodiments.

FIG. 8 illustrates a block diagram of an example computing device for implementing one or more embodiments of the present disclosure.

### DETAILED DESCRIPTION

This disclosure describes one or more embodiments of a speaker identification system that analyzes a dialogue transcript to determine speaker names for sentences in the transcript utilizing a deep learning language model. In particular, in one or more embodiments, the speaker identification system obtains or generates a dialogue transcript with anonymous speaker identities (e.g., speaker 1, speaker 2, etc.). The speaker identification system analyzes the dialogue transcript to identify person names spoken in the transcript, and matches the spoken names with speakers of the sentences of the transcript.

To illustrate, in some embodiments, the speaker identification system determines a name spoken in the transcript utilizing a named entity recognition model. Moreover, in some embodiments, the speaker identification system determines sentences around the spoken name, such as a sentence spoken by a previous speaker, a sentence spoken by a current speaker (e.g., the sentence containing the spoken name), and a sentence spoken by a next speaker. Additionally, in some embodiments, the speaker identification system utilizes a language model to generate feature representations of the sentences and the spoken name. Furthermore, in some implementations, the speaker identification system determines a speaker name for one of the sentences by matching the spoken name with a speaker of one of the sentences. For example, in some embodiments, the speaker identification system utilizes the language model to compare the representation of the spoken name with the representations of the sentences.

In particular, in some embodiments, the speaker identification system determines pair vectors for each sentence representation by concatenating the sentence representation with the representation of the spoken name. Additionally, in some implementations, the speaker identification system determines probability scores from the pair vectors by processing the pair vectors through a feed-forward network of the language model to determine probability scores for the sentences. For instance, in some implementations, the probability scores indicate a likelihood whether the spoken name belongs to a speaker of the corresponding sentence.

In addition, in some implementations, the speaker identification system prepares a training dataset for a language model (e.g., to train the language model to identify speaker names for sentences of dialogue transcripts). For example, the speaker identification system extracts spoken names in a dialogue transcript and assigns the spoken names to speakers utilizing text matching. Moreover, the speaker identification system anonymizes the speakers for the training dataset by substituting the speaker names with generic speaker identities. In some implementations, the speaker identification system trains a language model utilizing the training dataset. For example, the speaker identification system trains a transformer-based model to observe spoken names in a transcript and identify matches between the spoken names and speakers of sentences in the transcript.

Although conventional transcription systems can generate textual transcripts of conferences from audio recordings, such systems have a number of problems in relation to flexibility of operation and accuracy. For instance, conventional systems often inflexibly require an audio recording or video recording of a conference to identify speaker names for the conference. For example, conventional systems often require audio to utilize voice recognition techniques for determining speaker names.

Additionally, conventional systems often inaccurately identify speaker names for the sentences of a transcript. For example, conventional systems often err when determining speaker names from an audio recording, or even omit speaker names from portions of the conference.

The speaker identification system provides a variety of technical advantages relative to conventional systems. For example, the speaker identification system provides a novel approach to identifying speaker names in transcripts. In particular, the speaker identification system identifies speaker names for a dialogue transcript without using an audio recording of the conversation. For instance, the speaker identification system analyzes the transcript to determine speakers of sentences from textual information, without requiring audio or video information.

Moreover, by utilizing a trained language model to generate feature representations and form pair vectors for sentences and names, the speaker identification system accurately identifies speakers of sentences in the transcript. In particular, the speaker identification system achieves good precision and recall metrics for correctly identifying speaker names.

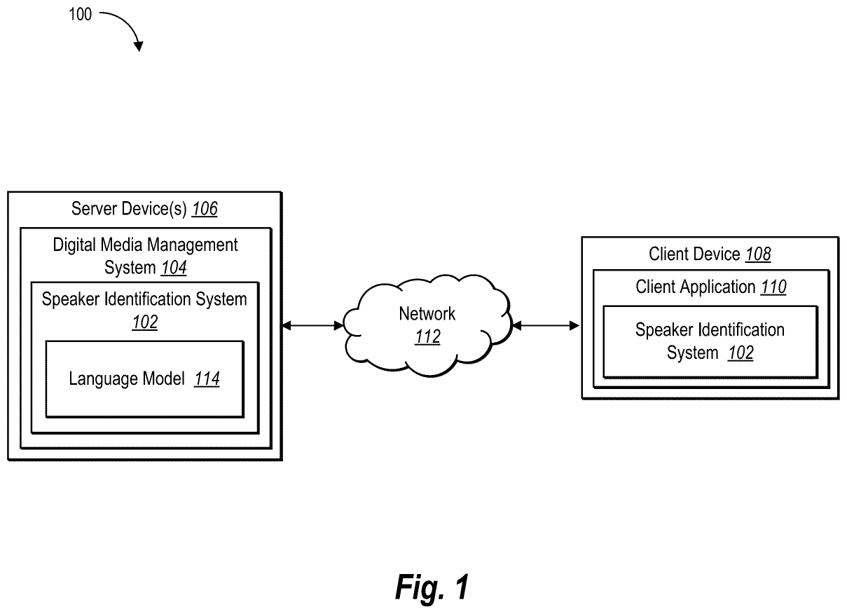

Additional detail will now be provided in relation to illustrative figures portraying example embodiments and implementations of a speaker identification system. For example, FIG. 1 illustrates a system 100 (or environment) in which a speaker identification system 102 operates in accordance with one or more embodiments. As illustrated, the system 100 includes server device(s) 106, a network 112, and a client device 108. As further illustrated, the server device(s) 106 and the client device 108 communicate with one another via the network 112.

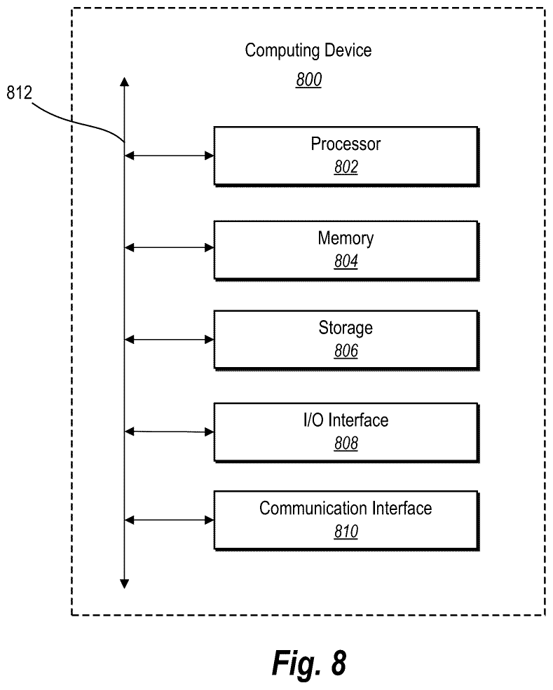

As shown in FIG. 1, the server device(s) 106 includes a digital media management system 104 that further includes the speaker identification system 102. In some embodiments, the speaker identification system 102 determines speaker names for sentences of a textual transcript. In some embodiments, the speaker identification system 102 utilizes a machine learning model (such as a language model 114) to generate feature representations of sentences and of spoken names, and utilizes the feature representations to determine the speaker names. In some embodiments, the speaker identification system 102 generates a training dataset for the language model 114 (or for a different language model) as described herein. In some embodiments, the server device(s) 106 includes, but is not limited to, a computing device (such as explained below with reference to FIG. 8).

In some instances, the speaker identification system 102 receives a request (e.g., from the client device 108) to identify speaker names in a transcript. For example, the speaker identification system 102 receives a transcript with unidentified speakers and, in response to the request to identify speaker names, matches names spoken in the transcript to speaker names for sentences of the transcript. Some embodiments of server device(s) 106 perform a variety of functions via the digital media management system 104 on the server device(s) 106. To illustrate, the server device(s) 106 (through the speaker identification system 102 on the digital media management system 104) performs functions such as, but not limited to, determining sentences spoken by anonymous speakers in a transcript, generating feature representations of the sentences, generating name representations of names spoken in the sentences, comparing feature representations with name representations, and determining speakers for one or more sentences in the transcript. In some embodiments, the server device(s) 106 utilizes the language model 114 to generate the feature representations for the sentences and/or the name representations for names spoken in the sentences. In some embodiments, the server device(s) 106 trains the language model 114.

Furthermore, as shown in FIG. 1, the system 100 includes the client device 108. In some embodiments, the client device 108 includes, but is not limited to, a mobile device (e.g., a smartphone, a tablet), a laptop computer, a desktop computer, or any other type of computing device, including those explained below with reference to FIG. 8. Some embodiments of client device 108 perform a variety of functions via a client application 110 on client device 108. For example, the client device 108 (through the client application 110) performs functions such as, but not limited to, determining sentences spoken by anonymous speakers in a transcript, generating feature representations of the sentences, generating name representations of names spoken in the sentences, comparing feature representations with name representations, and determining speakers for one or more sentences in the transcript. In some embodiments, the client device 108 utilizes the language model 114 to generate the feature representations for the sentences and/or the name representations for names spoken in the sentences. In some embodiments, the client device 108 trains the language model 114.

To access the functionalities of the speaker identification system 102 (as described above and in greater detail below), in one or more embodiments, a user interacts with the client application 110 on the client device 108. For example, the client application 110 includes one or more software applications (e.g., to interact with transcripts in accordance with one or more embodiments described herein) installed on the client device 108, such as a digital media management application, a text editing application, and/or a transcription application. In certain instances, the client application 110 is hosted on the server device(s) 106. Additionally, when hosted on the server device(s) 106, the client application 110 is accessed by the client device 108 through a web browser and/or another online interfacing platform and/or tool.

As illustrated in FIG. 1, in some embodiments, the speaker identification system 102 is hosted by the client application 110 on the client device 108 (e.g., additionally or alternatively to being hosted by the digital media management system 104 on the server device(s) 106). For example, the speaker identification system 102 performs the speaker identification techniques described herein on the client device 108. In some implementations, the speaker identification system 102 utilizes the server device(s) 106 to train and implement machine learning models (such as the language model 114). In one or more embodiments, the speaker identification system 102 utilizes the server device(s) 106 to train machine learning models (such as the language model 114) and utilizes the client device 108 to implement or apply the machine learning models.

Further, although FIG. 1 illustrates the speaker identification system 102 being implemented by a particular component and/or device within the system 100 (e.g., the server device(s) 106 and/or the client device 108), in some embodiments the speaker identification system 102 is implemented, in whole or in part, by other computing devices and/or components in the system 100. For instance, in some embodiments, the speaker identification system 102 is implemented on another client device. More specifically, in one or more embodiments, the description of (and acts performed by) the speaker identification system 102 are implemented by (or performed by) the client application 110 on another client device.

In some embodiments, the client application 110 includes a web hosting application that allows the client device 108 to interact with content and services hosted on the server device(s) 106. To illustrate, in one or more implementations, the client device 108 accesses a web page or computing application supported by the server device(s) 106. The client device 108 provides input to the server device(s) 106 (e.g., a transcript). In response, the speaker identification system 102 on the server device(s) 106 performs operations described herein to identify speaker names of sentences in the transcript. The server device(s) 106 provides the output or results of the operations (e.g., the speaker names matched to sentences in the transcript) to the client device 108. As another example, in some implementations, the speaker identification system 102 on the client device 108 performs operations described herein to identify speaker names of sentences in the transcript. The client device 108 provides the output or results of the operations (e.g., the speaker names matched to sentences in the transcript) via a display of the client device 108, and/or transmits the output or results of the operations to another device (e.g., the server device(s) 106 and/or another client device).

Additionally, as shown in FIG. 1, the system 100 includes the network 112. As mentioned above, in some instances, the network 112 enables communication between components of the system 100. In certain embodiments, the network 112 includes a suitable network and may communicate using any communication platforms and technologies suitable for transporting data and/or communication signals, examples of which are described with reference to FIG. 8. Furthermore, although FIG. 1 illustrates the server device(s) 106 and the client device 108 communicating via the network 112, in certain embodiments, the various components of the system 100 communicate and/or interact via other methods (e.g., the server device(s) 106 and the client device 108 communicate directly).

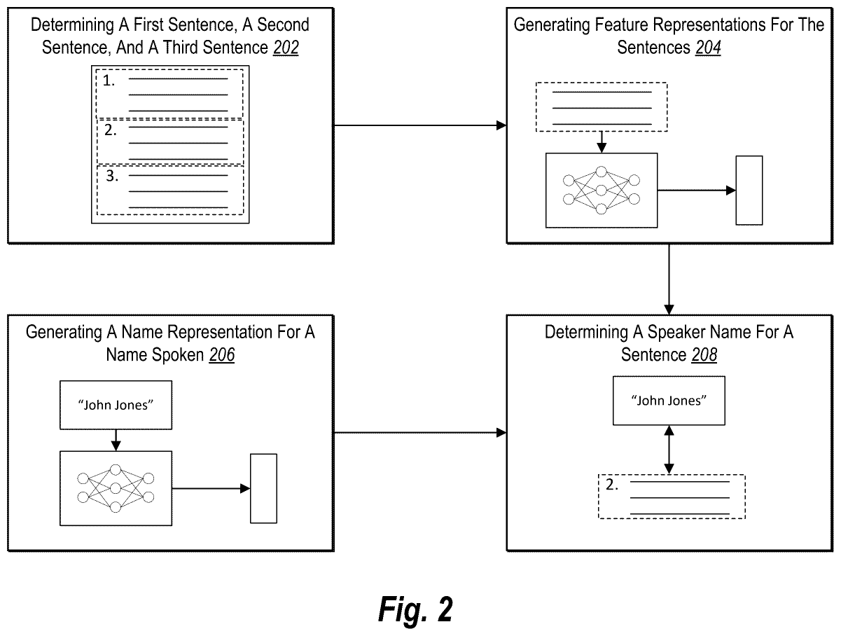

As discussed, in some embodiments, the speaker identification system 102 identifies speaker names in transcripts. For instance, FIG. 2 illustrates the speaker identification system 102 generating feature representations for sentences and a spoken name in a transcript, and determining a speaker name for a sentence in accordance with one or more embodiments.

Specifically, FIG. 2 shows the speaker identification system 102 performing an act 202 of determining a first sentence, a second sentence, and a third sentence in a transcript. For example, the speaker identification system 102 determines, from a set of sentences in a textual transcript, a first sentence spoken by a first speaker, a second sentence spoken by a second speaker, and a third sentence spoken by a third speaker. To illustrate, in some implementations, the speaker identification system 102 detects a spoken name in a sentence spoken by a speaker (e.g., the second speaker). Additionally, the speaker identification system 102 determines adjacent sentences spoken by a previous speaker and a next speaker (e.g., the most recent sentence spoken by the first speaker and the next sentence spoken by the third speaker). As described in further detail below, in some implementations, the speaker identification system 102 utilizes one or more models to detect the spoken name and the sentences.

In some implementations, the speaker identification system 102 determines more than three sentences (e.g., four sentences, five sentences, etc.) to identify a speaker name for one or more of the sentences. Alternatively, in some implementations, the speaker identification system 102 determines fewer than three sentences (e.g., two sentences or one sentence) to identify a speaker name for one or both sentences. For example, the speaker identification system 102 determines, from a set of sentences in a textual transcript of a dialogue, a first sentence spoken by a first speaker and a second sentence spoken by a second speaker.

Additionally, FIG. 2 shows the speaker identification system 102 performing an act 204 of generating feature representations for the sentences. For example, the speaker identification system 102 generates, utilizing a language model, a first feature representation for the first sentence, a second feature representation for the second sentence, and a third feature representation for the third sentence. In some implementations (e.g., in cases in which the speaker identification system 102 determines just two sentences), the speaker identification system 102 generates a first feature representation for the first sentence and a second feature representation for the second sentence.

Moreover, FIG. 2 shows the speaker identification system 102 performing an act 206 of generating a name representation for a name spoken in the sentences. For example, the speaker identification system 102 generates a name representation for a name spoken in at least one of the first sentence, the second sentence, or the third sentence. In some implementations (e.g., in cases in which the speaker identification system 102 determines just two sentences), the speaker identification system 102 generates a name representation for a name spoken in at least one of the first sentence or the second sentence.

Furthermore, FIG. 2 shows the speaker identification system 102 performing an act 208 of determining a speaker name for a sentence in the transcript. For example, the speaker identification system 102 determines a speaker name for at least one of the first sentence, the second sentence, or the third sentence by comparing each of the first feature representation, the second feature representation, and the third feature representation with the name representation for the spoken name. For instance, the speaker identification system 102 compares the first feature representation with the name representation to determine whether the spoken name corresponds to the first speaker of the first sentence, compares the second feature representation with the name representation to determine whether the spoken name corresponds to the second speaker of the second sentence, and compares the third feature representation with the name representation to determine whether the spoken name corresponds to the third speaker of the third sentence. In some implementations (e.g., in cases in which the speaker identification system 102 determines just two sentences), the speaker identification system 102 compares each of the first feature representation and the second feature representation with the name representation to determine a speaker name for at least one of the first sentence or the second sentence.

In some implementations, the speaker identification system 102 determines the sentences in a sequential order (e.g., a temporal order). For example, the speaker identification system 102 determines that the first speaker spoke the first sentence before the second speaker spoke the second sentence, and that the second speaker spoke the second sentence before the third speaker spoke the third sentence. In some implementations (e.g., in cases in which the speaker identification system 102 determines just two sentences), the speaker identification system 102 determines that the first sentence is spoken before the second sentence.

As mentioned, in some embodiments, the speaker identification system 102 determines the sentences (e.g., the first, second, and third sentences) by first identifying a name spoken in the transcript. Then, in some embodiments, the speaker identification system 102 identifies the sentence containing the name (e.g., the current speaker's sentence), a sentence spoken by a different speaker before the sentence containing the name (e.g., the previous speaker's sentence), and a sentence spoken by yet another speaker after the sentence containing the name (e.g., the next speaker's sentence).

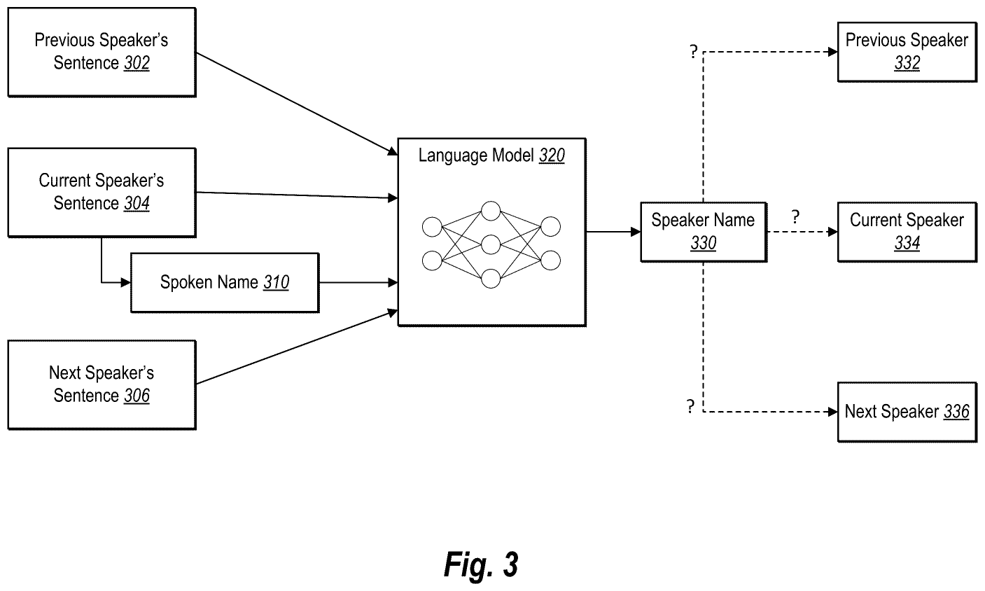

As discussed above, in some embodiments, the speaker identification system 102 matches names spoken in a dialogue transcript with speakers of sentences of the transcript. For instance, FIG. 3 illustrates the speaker identification system 102 determining a speaker name from a spoken name in accordance with one or more embodiments. A transcript includes a textual record of spoken words. For example, a transcript includes a written record of a dialogue or of speech. A dialogue includes a conversation, a meeting, a conference, an interview, a news cast, a press conference, or a lecture.

Specifically, FIG. 3 shows the speaker identification system 102 identifying—from a dialogue transcript-a previous speaker's sentence 302, a current speaker's sentence 304, and a next speaker's sentence 306. In addition, FIG. 3 shows the speaker identification system 102 identifying a spoken name 310 (e.g., a name spoken in the current speaker's sentence 304). As also shown, in some embodiments, the speaker identification system 102 processes the previous speaker's sentence 302, the current speaker's sentence 304, the next speaker's sentence 306, and the spoken name 310 through a language model 320 (e.g., the language model 114) to determine a speaker name 330.

As just mentioned, in some implementations, the speaker identification system 102 utilizes the language model 320 to determine the speaker name 330. For example, the speaker identification system 102 determines that the spoken name 310 corresponds with a speaker of one or more sentences in the transcript. As shown in FIG. 3, in some implementations, the speaker identification system 102 determines that the speaker name 330 corresponds with one (or more) of a previous speaker 332 (e.g., the speaker of the previous speaker's sentence 302), a current speaker 334 (e.g., the speaker of the current speaker's sentence 304), or a next speaker 336 (e.g., the speaker of the next speaker's sentence 306).

In some cases, the spoken name 310 belongs to one of the previous speaker 332 (e.g., the current speaker thanks the previous speaker), the current speaker 334 (e.g., the current speaker gives a self-introduction), or the next speaker 336 (e.g., the current speaker introduces the next speaker). Thus, in some implementations, the speaker identification system 102 identifies the previous speaker's sentence 302, the current speaker's sentence 304, and the next speaker's sentence 306 to evaluate these sentences together and increase the likelihood of correctly matching the spoken name 310 (as the speaker name 330) to one of the speakers of the sentences.

A language model includes a machine learning model, neural network, or deep learning model that analyzes features of linguistic patterns (e.g., speech, text, etc.) to generate predictions about the linguistic patterns. A machine learning model includes a computer representation that is tunable (e.g., trained) based on inputs to approximate unknown functions used for generating corresponding outputs. In particular, in one or more embodiments, a machine learning model is a computer-implemented model that utilizes algorithms to learn from, and make predictions on, known data by analyzing the known data to learn to generate outputs that reflect patterns and attributes of the known data. For instance, in some cases, a machine learning model includes, but is not limited to, a neural network (e.g., a convolutional neural network, recurrent neural network, or other deep learning network), a decision tree (e.g., a gradient boosted decision tree), support vector learning, Bayesian networks, a transformer-based model, a diffusion model, or a combination thereof.

Similarly, a neural network includes a set of one or more machine learning models that is trainable and/or tunable based on inputs to determine classifications and/or scores, or to approximate unknown functions. For example, in some cases, a neural network includes a model of interconnected artificial neurons (e.g., organized in layers) that communicate and learn to approximate complex functions and generate outputs based on inputs provided to the neural network. In some cases, a neural network refers to an algorithm (or set of algorithms) that implements deep learning techniques to model high-level abstractions in data. A neural network includes various layers such as an input layer, one or more hidden layers, and an output layer that each perform tasks for processing data. For example, a neural network includes a deep neural network, a convolutional neural network, a diffusion neural network, a recurrent neural network (e.g., an LSTM), a graph neural network, a transformer, or a generative adversarial neural network.

To illustrate further, in some embodiments, the speaker identification system 102 concatenates the first sentence (e.g., the previous speaker's sentence 302), the second sentence (e.g., the current speaker's sentence 304), and the third sentence (e.g., the next speaker's sentence 306) into a text sequence. Furthermore, as mentioned above, the speaker identification system 102 generates feature representations for the sentences. For instance, the speaker identification system 102 generates each of the first feature representation for the first sentence, the second feature representation for the second sentence, and the third feature representation for the third sentence by processing the text sequence through the language model 320 to determine word representations from the first sentence, the second sentence, and the third sentence. In some implementations (e.g., in cases in which the speaker identification system 102 determines just two sentences from the transcript), the speaker identification system 102 concatenates the first sentence and the second sentence into a text sequence. Additionally, the speaker identification system 102 generates the first feature representation for the first sentence and the second feature representation for the second sentence by processing the text sequence through a trained language model (e.g., the language model 320) to determine word representations from the first sentence and the second sentence.

A feature representation includes a numerical representation of features of a text string (e.g., features suggesting a semantic connotation or meaning, such as words in a sentence or a name). For instance, in some cases, a feature representation includes a feature vector or feature token of a sentence. To illustrate, a feature representation includes a latent feature vector representation of a sentence generated by one or more layers of a neural network. A name representation includes a numerical representation of features of a name (e.g., a person's name). For instance, a name representation includes a feature vector or feature token of words or components in a name.

Moreover, in some implementations, the speaker identification system 102 generates the feature representations by averaging word representations in the sentences. To illustrate, the speaker identification system 102 utilizes the language model 320 to generate contextualized representations for subwords of the text sequence (i.e., the sentences concatenated together). The speaker identification system 102 computes an average sum of the subword representations to determine a representation for the words in the text sequence. The speaker identification system 102 then averages over the word representations to generate a representation for each sentence. For instance, the speaker identification system 102 generates the first feature representation for the first sentence by averaging word representations for each word in the first sentence.

Furthermore, in some embodiments, the speaker identification system 102 generates the name representation by computing an average sum of words in a span of the spoken name 310. For instance, the speaker identification system 102 generates the name representation for the spoken name by averaging feature vectors for each word in the spoken name.

In some implementations, the speaker identification system 102 utilizes the feature representations of the sentences as speaker representations for the speakers of the sentences. For example, the speaker identification system 102 utilizes the first feature representation for the first sentence as a speaker representation for the first speaker. Thus, the speaker identification system 102 identifies semantic information (via the feature representations of the sentences) that is representative of the speakers of the sentences in the transcript. In this way, the speaker identification system 102 can identify (e.g., utilizing the language model 320) speakers of the sentences based on spoken names in the sentences.

To perform the speaker identification techniques, in some embodiments, the speaker identification system 102 forms pair vectors from the feature representations of the sentences and the name representation of the spoken name. For example, the speaker identification system 102 determines a first pair vector from the first feature representation and the name representation, a second pair vector from the second feature representation and the name representation, and a third pair vector from the third feature representation and the name representation. To illustrate, the speaker identification system 102 concatenates the name representation with each of the feature representations. For instance, the speaker identification system 102 concatenates the name representation with the first feature representation to determine the first pair vector for the first sentence.

Furthermore, in some implementations, the speaker identification system 102 determines probability scores for each speaker of the sentences with respect to the spoken name 310. For example, the speaker identification system 102 determines a probability score for the first feature representation indicating a probability that the speaker name 330 belongs to the first speaker (e.g., the previous speaker 332). In some embodiments, the speaker identification system 102 utilizes the pair vectors to determine the probability scores. For instance, the speaker identification system 102 determines, from the first pair vector utilizing a feed-forward network of the language model 320, a first probability score for the spoken name 310. Similarly, the speaker identification system 102 determines, from the second pair vector utilizing the feed-forward network of the language model 320, a second probability score for the spoken name 310. Likewise, the speaker identification system 102 determines, from the third pair vector utilizing the feed-forward network of the language model 320, a third probability score for the spoken name 310.

Stated another way, in some embodiments, the speaker identification system 102 compares the first feature representation with the name representation by determining a probability score for the first feature representation indicating a first probability that the speaker name 330 belongs to the first speaker (e.g., the previous speaker 332). Similarly, the speaker identification system 102 compares the second feature representation with the name representation by determining a probability score for the second feature representation indicating a second probability that the speaker name 330 belongs to the second speaker (e.g., the current speaker 334).

In some implementations, the speaker identification system 102 identifies the speaker name 330 for a sentence in the transcript by matching the spoken name 310 with a speaker of the sentence. For instance, the speaker identification system 102 utilizes the probability scores to identify the match. To illustrate, the speaker identification system 102 compares the first probability score, the second probability score, and the third probability score to determine a match between the spoken name 310 and at least one of the first speaker (e.g., the previous speaker 332), the second speaker (e.g., the current speaker 334), or the third speaker (e.g., the next speaker 336). As explained above, in some implementations, the speaker identification system 102 evaluates more or fewer than three sentences. Thus, the example of comparing three probability scores is illustrative only, and not limiting.

As mentioned, in some embodiments, the speaker identification system 102 utilizes a feed-forward network to determine the probability scores. In some implementations, the feed-forward network is a multilayer perceptron. In some cases, the feed-forward network has a sigmoid output function. Thus, in some cases, the speaker identification system 102 processes the pair vectors through the feed-forward network to generate a probability score that has a value between zero and one. In some implementations, the speaker identification system 102 trains the language model 320 by minimizing a cross-entropy loss function based on the probability scores. For example, the speaker identification system 102 tunes parameters of the language model 320 to reduce the cross-entropy loss.

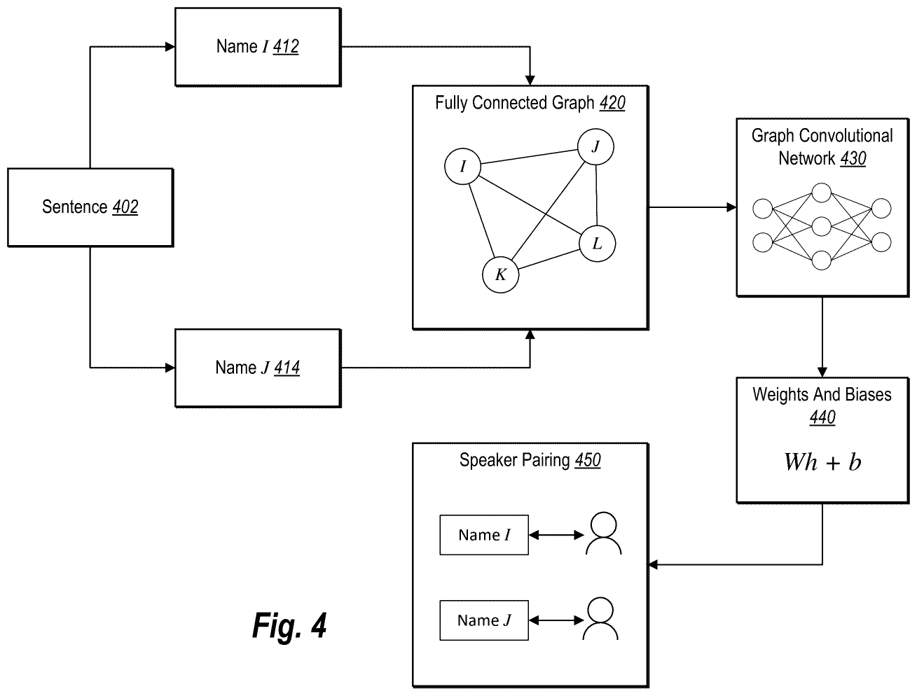

As mentioned, in some embodiments, the speaker identification system 102 identifies multiple speaker names for a transcript from one sentence of the transcript. For instance, FIG. 4 illustrates the speaker identification system 102 determining multiple speaker names from a single sentence of the transcript in accordance with one or more embodiments.

Specifically, FIG. 4 shows the speaker identification system 102 identifying a sentence 402 in a transcript. The speaker identification system 102 also identifies a first spoken name 412 and a second spoken name 414, both of which were spoken in the sentence 402. In some cases, the speaker identification system 102 identifies more names (e.g., three names, four names, etc.) spoken in the sentence 402. In some embodiments, the speaker identification system 102 generates a fully connected graph 420 containing nodes and edges, where the nodes represent the names (e.g., as name representations generated by the language model 320), and the edges represent similarities between the names (e.g., a shorter edge denotes a closer similarity). Furthermore, in some embodiments, the speaker identification system 102 determines edge weights for each edge by measuring a cosine similarity score between the two names connected by the edge.

In addition, in some implementations, the speaker identification system 102 utilizes a graph convolutional network 430 with weights and biases 440 to determine enhanced name representations for the spoken names. For instance, the speaker identification system 102 processes name representations for the first spoken name 412 and the second spoken name 414, along with their associated edge weight, through the graph convolutional network 430 to determine a first enhanced name representation for the first spoken name 412 and a second enhanced name representation for the second spoken name 414.

In some implementations, the speaker identification system 102 utilizes speaker pairing 450 to pair the enhanced name representations with speaker representations (e.g. feature representations for sentences) in a fashion similar to (or the same as) that described above in connection with FIGS. 2 and 3. In some cases, there might be multiple names paired with a single speaker representation. To determine a speaker name for the speaker representation, the speaker identification system 102 selects the name representation with the highest probability score.

Stated differently, in some implementations, the speaker identification system 102 determines that at least one of the first sentence or the second sentence (or the third sentence, etc.) comprises multiple spoken names. Then, the speaker identification system 102 generates name representations for each of the multiple spoken names. The speaker identification system 102 compares each of the name representations with each of the first feature representation and the second feature representation to determine probability scores for each of the name representations, wherein the probability scores indicate probabilities that corresponding names of the multiple spoken names belong to the first speaker (or to the second speaker, etc.).

The techniques described above in connection with FIG. 4 can be represented symbolically. For example, given K person names spoken in a given sentence, the speaker identification system 102 determines name representations for the K names as r₁, r₂, . . . , r_{K}. The speaker identification system 102 determines the edge weight aᵢⱼ between the ith and jth spoken names as

$${α}_{ij} = softmax ( \frac{{r}_{i}^{τ} {r}_{j}}{{\sum }_{{j}^{′}} {r}_{i}^{τ} {r}_{{j}^{′}}} ) .$$

Additionally, the speaker identification system 102 determines enhanced name representations via L layers of the graph convolutional network 430 as: hᵢ^{l}=ReLU (Σⱼ₌₁^{K}aᵢⱼ W^{l}hⱼ^{l-1}+b^{l}), where W^{l} and b^{l} are, respectively, a learnable weight matrix and bias for the layer l of the graph convolutional network 430, and hᵢ^{o}≡rᵢ is the input representation for the ith spoken name.

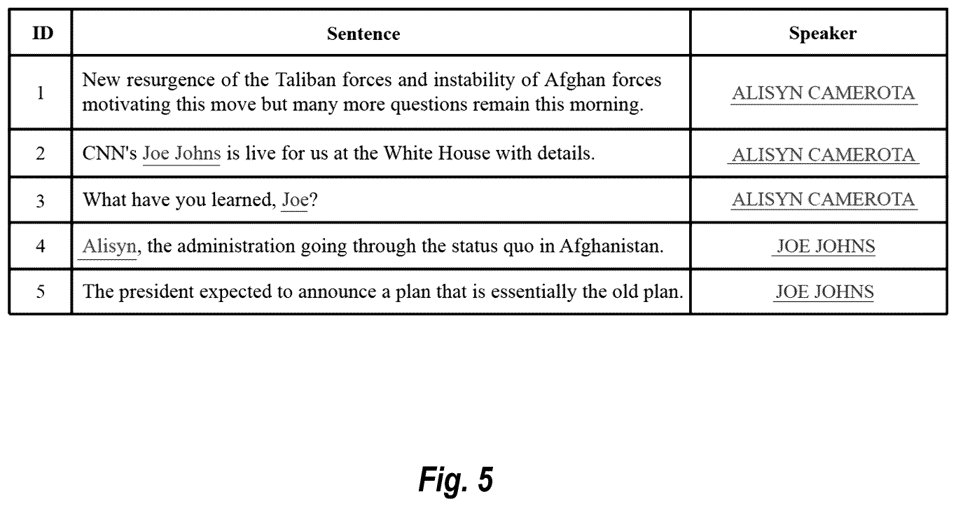

As mentioned, in some embodiments, the speaker identification system 102 develops a training dataset for one or more machine learning models. For instance, FIG. 5 illustrates the speaker identification system 102 generating a training dataset for a language model in accordance with one or more embodiments.

Specifically, FIG. 5 shows an example excerpt of a transcript for a training dataset. The excerpt includes sentences from the transcript and speaker names for the sentences. In some implementations, the speaker identification system 102 generates a training dataset for the language model by identifying the speaker names in the transcript, anonymizing the speaker names by replacing the speaker names with generic speaker identities, identifying spoken names within sentences of the transcript, and mapping at least a subset of the spoken names to one or more of the generic speaker identities based on the speaker names.

To illustrate the example in FIG. 5, the speaker identification system 102 identifies the speaker names “Alisyn Camerota” and “Joe Johns.” The speaker identification system 102 anonymizes these speaker names by replacing them with generic speaker identities (e.g., “Alisyn Camerota” becomes “speaker 1,” and “Joe Johns” becomes “speaker 2”). The speaker identification system 102 also detects spoken names in the transcript: “Joe Johns” in sentence 2, “Joe” in sentence 3, and “Alisyn” in sentence 4. The speaker identification system 102 maps the detected spoken names to the generic speaker identities. For example, the speaker identification system 102 maps the name “Alisyn” spoken in sentence 4 to the generic speaker identity “speaker 1.” For spoken names that do not match a speaker, the speaker identification system 102 maps the name to a null speaker identity.

In some embodiments, the speaker identification system 102 utilizes a named entity recognition model to detect the spoken names in the transcript. For example, in some embodiments, the speaker identification system 102 utilizes the transformer-based model described by Nguyen et al. in Trankit: A light-weight transformer-based toolkit for multilingual natural language processing, in Proceedings of the 16th Conference of the European Chapter of the Association for Computational Linguistics: System Demonstrations (2021), which is hereby incorporated by reference in its entirety. In some implementations, the speaker identification system 102 matches spoken names with speaker names utilizing the Levenshtein Distance to perform fuzzy text matching.

Experimental tests were performed utilizing the speaker identification system 102. In particular, the speaker identification system 102 sampled two hundred dialogue transcripts, with eighty percent of the transcripts used as training transcripts, ten percent as development transcripts, and ten percent as test transcripts. Statistics for the experimental dataset are shown in the following table.

| Dataset | # transcripts | # sentences | # spoken names | # speakers |
|---|---|---|---|---|
| Train | 160 | 17,440 | 5,170 | 962 |
| Dev | 21 | 1,719 | 570 | 118 |
| Test | 19 | 1,562 | 429 | 106 |

The performance of the speaker identification system 102 was evaluated by calculating the number of speakers that the speaker identification system 102 successfully matched with spoken names in the transcripts. Evaluation metrics included precision and recall scores.

The speaker identification system 102 achieved a precision score of 80.3% and a recall score of 50.0%. The recall score is limited because not all speaker names are mentioned in the transcripts (e.g., some speakers of sentences contribute to the dialogue, but their names are not spoken in the dialogue). For example, in the test transcripts, while there are 106 speakers, there are only 71 speakers that have their names spoken. Thus, an upper bound of the recall score is 67.0%. Therefore, the speaker identification system 102 successfully found 74.6% of the speaker names in the transcripts.

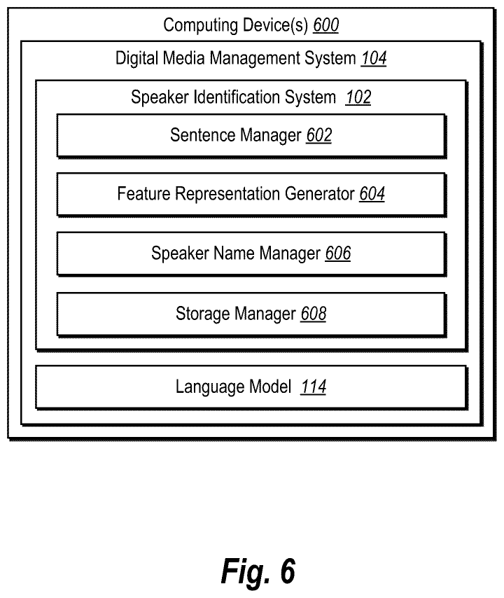

Turning now to FIG. 6, additional detail will be provided regarding components and capabilities of one or more embodiments of the speaker identification system 102. In particular, FIG. 6 illustrates an example speaker identification system 102 executed by a computing device(s) 600 (e.g., the server device(s) 106 or the client device 108). As shown by the embodiment of FIG. 6, the computing device(s) 600 includes or hosts the digital media management system 104, the speaker identification system 102, and the language model 114. Furthermore, as shown in FIG. 6, the speaker identification system 102 includes a sentence manager 602, a feature representation generator 604, a speaker name manager 606, and a storage manager 608.

As shown in FIG. 6, the speaker identification system 102 includes a sentence manager 602. In some implementations, the sentence manager 602 identifies one or more sentences from a transcript. For example, the sentence manager 602 determines a first sentence, a second sentence, and a third sentence from a set of sentences in the transcript.

In addition, as shown in FIG. 6, the speaker identification system 102 includes a feature representation generator 604. In some implementations, the feature representation generator 604 generates feature representations for the sentences. For example, the feature representation generator 604 utilizes a language model (e.g., the language model 114) to generate a first feature representation for the first sentence, a second feature representation for the second sentence, and a third feature representation for the third sentence.

Moreover, as shown in FIG. 6, the speaker identification system 102 includes a speaker name manager 606. In some implementations, the speaker name manager 606 detects names spoken in the transcript. Additionally, in some implementations, the speaker name manager 606 generates name representations for the spoken names. For example, the speaker name manager 606 generates a name representation for a spoken name in at least one of the first sentence, the second sentence, or the third sentence. Furthermore, the speaker name manager 606 compares the feature representations with the name representation to determine a speaker name for a sentence. For instance, the speaker name manager 606 determines the speaker name for at least one of the first sentence, the second sentence, or the third sentence by comparing each of the first feature representation, the second feature representation, and the third feature representation with the name representation for the spoken name.

Furthermore, as shown in FIG. 6, the speaker identification system 102 includes a storage manager 608. In some implementations, the storage manager 608 stores information (e.g., via one or more memory devices) on behalf of the speaker identification system 102. For example, the storage manager 608 includes one or more text transcripts of dialogues, feature representations of sentences, name representations of spoken names, and speaker names determined for one or more sentences in the transcripts. Additionally, in some implementations, the storage manager 608 stores parameters of one or more machine learning models, including the language model 114.

Each of the components 602-608 of the speaker identification system 102 can include software, hardware, or both. For example, the components 602-608 can include one or more instructions stored on a computer-readable storage medium and executable by processors of one or more computing devices, such as a client device or server device. When executed by the one or more processors, the computer-executable instructions of the speaker identification system 102 can cause the computing device(s) to perform the methods described herein. Alternatively, the components 602-608 can include hardware, such as a special purpose processing device to perform a certain function or group of functions. Alternatively, the components 602-608 of the speaker identification system 102 can include a combination of computer-executable instructions and hardware.

Furthermore, the components 602-608 of the speaker identification system 102 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 602-608 may be implemented as a stand-alone application, such as a desktop or mobile application. Furthermore, the components 602-608 may be implemented as one or more web-based applications hosted on a remote server. The components 602-608 may also be implemented in a suite of mobile device applications or “apps.” To illustrate, the components 602-608 may be implemented in an application, including but not limited to Adobe Creative Cloud, Adobe Premiere, Adobe Sensei, and Behance. The foregoing are either registered trademarks or trademarks of Adobe in the United States and/or other countries.

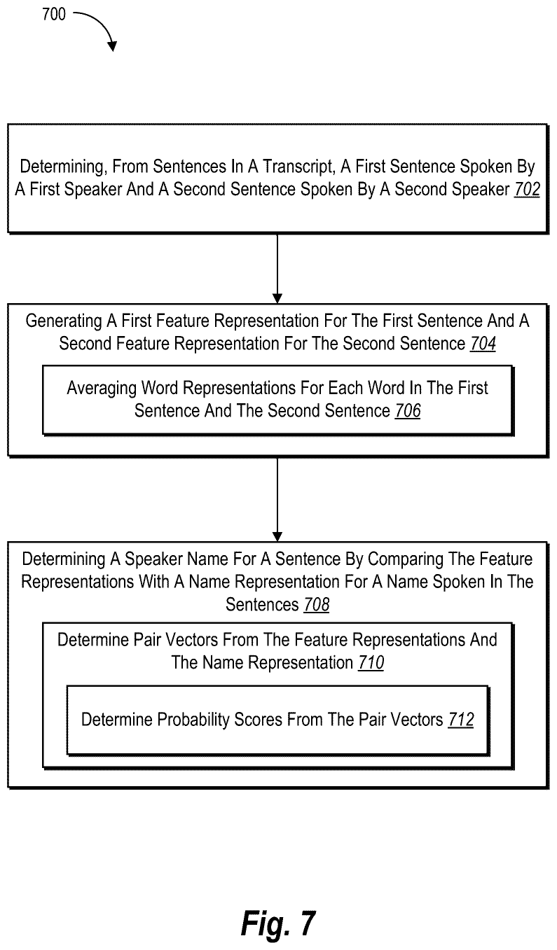

FIGS. 1-6, the corresponding text, and the examples provide a number of different methods, systems, devices, and non-transitory computer-readable media of the speaker identification system 102. In addition to the foregoing, one or more embodiments can also be described in terms of flowcharts comprising acts for accomplishing a particular result, as shown in FIG. 7. FIG. 7 may be performed with more or fewer acts. Further, the acts may be performed in differing orders. Additionally, the acts described herein may be repeated or performed in parallel with one another or parallel with different instances of the same or similar acts.

As mentioned, FIG. 7 illustrates a flowchart of a series of acts 700 for identifying speaker names in transcripts in accordance with one or more implementations. While FIG. 7 illustrates acts according to one implementation, alternative implementations may omit, add to, reorder, and/or modify any of the acts shown in FIG. 7. The acts of FIG. 7 can be performed as part of a method. Alternatively, a non-transitory computer-readable storage medium can comprise instructions that, when executed by one or more processors, cause a computing device to perform the acts of FIG. 7. In some implementations, a system performs the acts of FIG. 7.

As shown in FIG. 7, the series of acts 700 includes an act 702 of determining, from sentences in a transcript, a first sentence spoken by a first speaker and a second sentence spoken by a second speaker, an act 704 of generating a first feature representation for the first sentence and a second feature representation for the second sentence, and an act 708 of determining a speaker name for a sentence by comparing the feature representations with a name representation for a name spoken in the sentences. In addition, as shown in FIG. 7, the series of acts 700 includes an act 706 of averaging word representations for each word in the first sentence and the second sentence, an act 710 of determining pair vectors from the feature representations and the name representation, and an act 712 of determining probability scores from the pair vectors.

In particular, in some implementations, the act 702 includes determining, from a set of sentences in a textual transcript of a dialogue, a first sentence spoken by a first speaker and a second sentence spoken by a second speaker, the act 704 includes generating a first feature representation for the first sentence and a second feature representation for the second sentence, the series of acts 700 includes generating a name representation for a name spoken in at least one of the first sentence or the second sentence, and the act 708 includes comparing each of the first feature representation and the second feature representation with the name representation to determine a speaker name for at least one of the first sentence or the second sentence.

Moreover, in some implementations, the act 702 includes determining, from a set of sentences in a textual transcript, a first sentence spoken by a first speaker, a second sentence spoken by a second speaker, and a third sentence spoken by a third speaker, the act 704 includes generating, utilizing a language model, a first feature representation for the first sentence, a second feature representation for the second sentence, and a third feature representation for the third sentence, and the act 708 includes determining a speaker name for at least one of the first sentence, the second sentence, or the third sentence by comparing each of the first feature representation, the second feature representation, and the third feature representation with a name representation for a spoken name in at least one of the first sentence, the second sentence, or the third sentence.

Furthermore, in some implementations, the act 702 includes determining, from a set of sentences in a textual transcript of a dialogue, a first sentence spoken by a first speaker and a second sentence spoken by a second speaker, the act 704 includes generating a first feature representation for the first sentence and a second feature representation for the second sentence, and the act 708 includes determining a speaker name for at least one of the first sentence or the second sentence by comparing each of the first feature representation and the second feature representation with a name representation for a name spoken in at least one of the first sentence or the second sentence.

To illustrate, in some implementations, the series of acts 700 includes determining, from the set of sentences in the textual transcript, a third sentence spoken by a third speaker; generating a third feature representation for the third sentence; and comparing the third feature representation with the name representation to determine whether the speaker name corresponds to the third sentence.

In addition, in some implementations, the series of acts 700 includes determining the first sentence spoken by the first speaker and the second sentence spoken by the second speaker by determining that the first sentence is spoken before the second sentence. Furthermore, in some implementations, the series of acts 700 includes determining the first sentence, the second sentence, and the third sentence by determining that the first speaker spoke the first sentence before the second speaker spoke the second sentence, and that the second speaker spoke the second sentence before the third speaker spoke the third sentence.

Moreover, in some implementations, the series of acts 700 includes concatenating the first sentence and the second sentence into a text sequence; and generating the first feature representation for the first sentence and the second feature representation for the second sentence by processing the text sequence through a trained language model to determine word representations from the first sentence and the second sentence. In some implementations, the series of acts 700 includes concatenating the first sentence, the second sentence, and the third sentence into a text sequence; and generating each of the first feature representation for the first sentence, the second feature representation for the second sentence, and the third feature representation for the third sentence by processing the text sequence through the language model to determine word representations from the first sentence, the second sentence, and the third sentence.

Furthermore, in some implementations, the series of acts 700 includes determining a first pair vector from the first feature representation and the name representation; determining a second pair vector from the second feature representation and the name representation; and determining a third pair vector from the third feature representation and the name representation. In some implementations, the series of acts 700 includes concatenating the name representation with the first feature representation to determine a first pair vector for the first sentence.

Additionally, in some implementations, the series of acts 700 includes comparing the first feature representation with the name representation by determining a probability score for the first feature representation indicating a probability that the speaker name belongs to the first speaker. In some implementations, the series of acts 700 includes determining, from the first pair vector utilizing a feed-forward network of the language model, a first probability score for the spoken name; determining, from the second pair vector utilizing the feed-forward network of the language model, a second probability score for the spoken name; and determining, from the third pair vector utilizing the feed-forward network of the language model, a third probability score for the spoken name.

Furthermore, in some implementations, the series of acts 700 includes comparing the first feature representation with the name representation by determining a probability score for the first feature representation indicating a first probability that the speaker name belongs to the first speaker; and comparing the second feature representation with the name representation by determining a probability score for the second feature representation indicating a second probability that the speaker name belongs to the second speaker.

Moreover, in some implementations, the series of acts 700 includes concatenating the name representation with the first feature representation to determine a pair vector for the first sentence; and determining, from the pair vector for the first sentence, a probability score indicating a probability that the name belongs to the first speaker. Furthermore, in some implementations, the series of acts 700 includes comparing the first probability score, the second probability score, and the third probability score to determine a match between the spoken name and at least one of the first speaker, the second speaker, or the third speaker.

In addition, in some implementations, the series of acts 700 includes generating the name representation for the spoken name by averaging feature vectors for each word in the spoken name. Moreover, in some implementations, the series of acts 700 includes generating the first feature representation for the first sentence by averaging word representations for each word in the first sentence. Furthermore, in some implementations, the series of acts 700 includes generating the name representation for the name by averaging feature vectors for each word in the name; and generating the first feature representation for the first sentence by averaging word representations for each word in the first sentence.

Moreover, in some implementations, the series of acts 700 includes determining that the at least one of the first sentence or the second sentence comprises multiple spoken names; generating name representations for each of the multiple spoken names; and comparing each of the name representations with each of the first feature representation and the second feature representation to determine probability scores for each of the name representations, wherein the probability scores indicate probabilities that corresponding names of the multiple spoken names belong to the first speaker.

Furthermore, in some implementations, the series of acts 700 includes generating a training dataset for a language model by: identifying speaker names in a dialogue transcript; anonymizing the speaker names by replacing the speaker names with generic speaker identities; identifying spoken names within sentences of the dialogue transcript; and mapping at least a subset of the spoken names to one or more of the generic speaker identities based on the speaker names.

Embodiments of the present disclosure may comprise or utilize a special purpose or general purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions from a non-transitory computer-readable medium (e.g., memory) and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or generators and/or other electronic devices. When information is transferred, or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface generator (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general purpose computer, special purpose computer, or special purpose processing device to perform a certain function or group of functions. In some embodiments, computer-executable instructions are executed by a general purpose computer to turn the general purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program generators may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), a web service, Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 8 illustrates a block diagram of an example computing device 800 that may be configured to perform one or more of the processes described above. One will appreciate that one or more computing devices, such as the computing device 800, may represent the computing devices described above (e.g., the computing device(s) 600, the server device(s) 106, or the client device 108). In one or more embodiments, the computing device 800 may be a mobile device (e.g., a mobile telephone, a smartphone, a PDA, a tablet, a laptop, a camera, a tracker, a watch, a wearable device, etc.). In some embodiments, the computing device 800 may be a non-mobile device (e.g., a desktop computer or another type of client device). Further, the computing device 800 may be a server device that includes cloud-based processing and storage capabilities.

As shown in FIG. 8, the computing device 800 can include one or more processor(s) 802, memory 804, a storage device 806, input/output interfaces 808 (or “I/O interfaces 808”), and a communication interface 810, which may be communicatively coupled by way of a communication infrastructure (e.g., bus 812). While the computing device 800 is shown in FIG. 8, the components illustrated in FIG. 8 are not intended to be limiting. Additional or alternative components may be used in other embodiments. Furthermore, in certain embodiments, the computing device 800 includes fewer components than those shown in FIG. 8. Components of the computing device 800 shown in FIG. 8 will now be described in additional detail.

In particular embodiments, the processor(s) 802 includes hardware for executing instructions, such as those making up a computer program. As an example, and not by way of limitation, to execute instructions, the processor(s) 802 may retrieve (or fetch) the instructions from an internal register, an internal cache, memory 804, or a storage device 806 and decode and execute them.

The computing device 800 includes the memory 804, which is coupled to the processor(s) 802. The memory 804 may be used for storing data, metadata, and programs for execution by the processor(s). The memory 804 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 804 may be internal or distributed memory.

The computing device 800 includes the storage device 806 for storing data or instructions. As an example, and not by way of limitation, the storage device 806 can include a non-transitory storage medium described above. The storage device 806 may include a hard disk drive (“HDD”), flash memory, a Universal Serial Bus (“USB”) drive or a combination these or other storage devices.

As shown, the computing device 800 includes one or more I/O interfaces 808, which are provided to allow a user to provide input to (such as user strokes), receive output from, and otherwise transfer data to and from the computing device 800. These I/O interfaces 808 may include a mouse, keypad or a keyboard, a touch screen, camera, optical scanner, network interface, modem, other known I/O devices or a combination of such I/O interfaces 808. The touch screen may be activated with a stylus or a finger.

The I/O interfaces 808 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 808 are configured to provide graphical data to a display for presentation to a user. The graphical data may be representative of one or more graphical user interfaces and/or any other graphical content as may serve a particular implementation.

The computing device 800 can further include a communication interface 810. The communication interface 810 can include hardware, software, or both. The communication interface 810 provides one or more interfaces for communication (such as, for example, packet-based communication) between the computing device and one or more other computing devices or one or more networks. As an example, and not by way of limitation, communication interface 810 may include a network interface controller (“NIC”) or network adapter for communicating with an Ethernet or other wire-based network or a wireless NIC (“WNIC”) or wireless adapter for communicating with a wireless network, such as a WI-FI. The computing device 800 can further include the bus 812. The bus 812 can include hardware, software, or both that connects components of computing device 800 to each other.

The use in the foregoing description and in the appended claims of the terms “first,” “second,” “third,” etc., is not necessarily to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget, and not necessarily to connote that the second widget has two sides.

In the foregoing description, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with fewer or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
determining, from a set of sentences in a textual transcript of a dialogue, a first sentence spoken by a first speaker and a second sentence spoken by a second speaker;
generating a first feature representation for the first sentence and a second feature representation for the second sentence;
generating a name representation for a name spoken in at least one of the first sentence or the second sentence; and
comparing each of the first feature representation and the second feature representation with the name representation to determine a speaker name for at least one of the first sentence or the second sentence.

2. The computer-implemented method of claim 1, further comprising:
determining, from the set of sentences in the textual transcript, a third sentence spoken by a third speaker;
generating a third feature representation for the third sentence; and
comparing the third feature representation with the name representation to determine whether the speaker name corresponds to the third sentence.

3. The computer-implemented method of claim 1, wherein determining the first sentence spoken by the first speaker and the second sentence spoken by the second speaker comprises determining that the first sentence is spoken before the second sentence.

4. The computer-implemented method of claim 1, further comprising:
concatenating the first sentence and the second sentence into a text sequence; and
generating the first feature representation for the first sentence and the second feature representation for the second sentence by processing the text sequence through a trained language model to determine word representations from the first sentence and the second sentence.

5. The computer-implemented method of claim 1, wherein comparing the first feature representation with the name representation comprises determining a probability score for the first feature representation indicating a probability that the speaker name belongs to the first speaker.

6. The computer-implemented method of claim 1, further comprising:
determining that the at least one of the first sentence or the second sentence comprises multiple spoken names;
generating name representations for each of the multiple spoken names; and
comparing each of the name representations with each of the first feature representation and the second feature representation to determine probability scores for each of the name representations, wherein the probability scores indicate probabilities that corresponding names of the multiple spoken names belong to the first speaker.

7. A system comprising:
one or more memory devices comprising a language model and a textual transcript of a dialogue; and
one or more processors configured to cause the system to:
determine, from a set of sentences in the textual transcript, a first sentence spoken by a first speaker, a second sentence spoken by a second speaker, and a third sentence spoken by a third speaker;
generate, utilizing the language model, a first feature representation for the first sentence, a second feature representation for the second sentence, and a third feature representation for the third sentence; and
determine a speaker name for at least one of the first sentence, the second sentence, or the third sentence by comparing each of the first feature representation, the second feature representation, and the third feature representation with a name representation for a spoken name in at least one of the first sentence, the second sentence, or the third sentence.

8. The system of claim 7, wherein the one or more processors are further configured to cause the system to:
determine a first pair vector from the first feature representation and the name representation;
determine a second pair vector from the second feature representation and the name representation; and
determine a third pair vector from the third feature representation and the name representation.

9. The system of claim 8, wherein the one or more processors are further configured to cause the system to:
determine, from the first pair vector utilizing a feed-forward network of the language model, a first probability score for the spoken name;
determine, from the second pair vector utilizing the feed-forward network of the language model, a second probability score for the spoken name; and
determine, from the third pair vector utilizing the feed-forward network of the language model, a third probability score for the spoken name.

10. The system of claim 9, wherein the one or more processors are further configured to cause the system to compare the first probability score, the second probability score, and the third probability score to determine a match between the spoken name and at least one of the first speaker, the second speaker, or the third speaker.

11. The system of claim 7, wherein the one or more processors are further configured to cause the system to generate the name representation for the spoken name by averaging feature vectors for each word in the spoken name.

12. The system of claim 11, wherein the one or more processors are configured to cause the system to generate the first feature representation for the first sentence by averaging word representations for each word in the first sentence.

13. The system of claim 12, wherein the one or more processors are further configured to cause the system to concatenate the name representation with the first feature representation to determine a first pair vector for the first sentence.

14. The system of claim 7, wherein the one or more processors are configured to cause the system to determine the first sentence, the second sentence, and the third sentence by determining that the first speaker spoke the first sentence before the second speaker spoke the second sentence, and that the second speaker spoke the second sentence before the third speaker spoke the third sentence.

15. The system of claim 7, wherein the one or more processors are further configured to cause the system to:
concatenate the first sentence, the second sentence, and the third sentence into a text sequence; and
generate each of the first feature representation for the first sentence, the second feature representation for the second sentence, and the third feature representation for the third sentence by processing the text sequence through the language model to determine word representations from the first sentence, the second sentence, and the third sentence.

16. A non-transitory computer-readable medium storing executable instructions that, when executed by a processing device, cause the processing device to perform operations comprising:
determining, from a set of sentences in a textual transcript of a dialogue, a first sentence spoken by a first speaker and a second sentence spoken by a second speaker;
generating a first feature representation for the first sentence and a second feature representation for the second sentence; and
determining a speaker name for at least one of the first sentence or the second sentence by comparing each of the first feature representation and the second feature representation with a name representation for a name spoken in at least one of the first sentence or the second sentence.

17. The non-transitory computer-readable medium of claim 16, further storing executable instructions that, when executed by the processing device, cause the processing device to perform operations comprising:
comparing the first feature representation with the name representation by determining a probability score for the first feature representation indicating a first probability that the speaker name belongs to the first speaker; and
comparing the second feature representation with the name representation by determining a probability score for the second feature representation indicating a second probability that the speaker name belongs to the second speaker.

18. The non-transitory computer-readable medium of claim 16, further storing executable instructions that, when executed by the processing device, cause the processing device to perform operations comprising:
generating the name representation for the name by averaging feature vectors for each word in the name; and
generating the first feature representation for the first sentence by averaging word representations for each word in the first sentence.

19. The non-transitory computer-readable medium of claim 18, further storing executable instructions that, when executed by the processing device, cause the processing device to perform operations comprising:
concatenating the name representation with the first feature representation to determine a pair vector for the first sentence; and
determining, from the pair vector for the first sentence, a probability score indicating a probability that the name belongs to the first speaker.

20. The non-transitory computer-readable medium of claim 16, further storing executable instructions that, when executed by the processing device, cause the processing device to generate a training dataset for a language model by:
identifying speaker names in a dialogue transcript;
anonymizing the speaker names by replacing the speaker names with generic speaker identities;
identifying spoken names within sentences of the dialogue transcript; and
mapping at least a subset of the spoken names to one or more of the generic speaker identities based on the speaker names.
